(19) United States
(12) Patent Application Publication
(10) Pub. No.: US 2012/0004950 A1
(43) Pub. Date: Jan. 5, 2012

(54) System and method for integrated offline audience validation

(75) Inventors: Andrew Julian, Melbourne (AU); Scott Julian, Melbourne (AU); James Robertson, Melbourne (AU); David Lin, Melbourne (AU)

(73) Assignee: EFFECTIVE MEASURE, Melbourne (AU)

(21) Appl. No.: 13/174,858

(22) Filed: Jul. 1, 2011

Related U.S. Application Data
(60) Provisional application No. 61/360,567, filed on Jul. 1, 2010.

(51) Int. Cl. G06Q 10/00; G06Q 30/00

(52) U.S. Cl. 705/7.32

(57) ABSTRACT

A method and system is presented for the integration of offline media tracking and measurement with an online audience validation system. In one embodiment, the system builds on the existing audience validation system functionality and enables advertisers and marketers to better track attendance and the consumption of offline media that is displayed at event for which tickets must be procured. In another embodiment, the system allows Advertisers and Marketers to track attendance and the exposure of ticket holders to specific media during the event and to subsequently use this information to target survey and offers to event attendees. In another embodiment, the ability to track online, mobile, and offline media affords the additional benefit to perform full conversion funnel tracking across those media that further enables CPA advertising as well.

### RELATED APPLICATIONS

This application claims the benefit of priority to pending U.S. Provisional Application No. 61/360,567, titled “System and method for integrated offline audience validation,” filed on Jul. 1, 2010, the contents of which are incorporated by reference herein.

### TECHNICAL FIELD

The present invention relates generally to the systems, components, processes and data structures for the integration of offline media tracking and measurement with an online audience validation system that may include a universal tag.

### BACKGROUND

The advent of online and mobile advertising has resulted in an increased demand for accountability on the effectiveness of advertising spends by marketers and the brands they represent. Online and mobile advertising differs markedly from the “old media” advertising models of broadcast TV, broadcast radio, and print in that the presence of a back channel enables marketers to more accurately track where advertisements are shown and if they are acted upon by those who see them. Unfortunately, this tracking ability is also not present for outdoor media which typically consists of large format displays that are viewed by crowds of people who are nearby.

A number of recent attempts have been made to address this issue: Typically the solution requires people to interact with some kind of local artifact in the form of a local access point (usually Wi-Fi® of the Wireless Fidelity Alliance, Inc. or Bluetooth® of Bluetooth SIG, Inc.) or an image (usually some kind of barcode or encoded representation that can be captured via camera) using a mobile device in possession of the user. These solutions require that the user make a conscious decision to interact with their local surrounds, and therefore do not accurately track who is nearby.

Advertisers and marketers also seek to many online and offline behavior by integrating specific information collated through consumer online browsing habits with the media that they consume outdoors. To date methods to this have been statistically based and at best only provide approximate estimates of the media exposure of consumers across multiple online and offline channels.

### SUMMARY

In one embodiment, a method and system for the integration of offline media tracking and measurement employs an online audience validation system. In one embodiment, the offline media tracking and measurement builds on the existing audience validation system functionality and enables advertisers and marketers to better track attendance and the consumption of offline media that is displayed at event for which tickets must be procured. In one embodiment, the system makes it possible for Advertisers and Marketers to track attendance and exposure of ticket holders to specific media during the event and to subsequently use this information to target survey and offers to event attendees. In another embodiment, the ability to track online, mobile, and offline media affords the additional benefit to perform full conversion funnel tracking across those media that further enables CPA advertising as well.

According to one aspect, although not necessarily the broadest or only aspect embodiments of the invention reside in a computer-implemented method of measuring, estimating, and correlating the exposure of event-based media through the creation of an association between:

a validated online transaction made by a person for one or more persons to attend an event; and

the set of demographic data determined about that person via the combination of:

the browsing profile resulting from their visiting sites upon which a universal tag has been placed to track media consumption; and

any responses supplied by that person to surveys that were launched by the same universal tag used to track media consumption; and

any additional information supplied by the person during the process of making the aforementioned transaction. This association may be created by the use of a universal-tag that is used to monitor and validate the consumption behavior of a person across multiple online media sites and applications that is also incorporated into an online transaction portal that creates an association between the anonymized identifying information within an instance of a universal-tag and the transaction between the user corresponding tag and an event organizer who provides an online site for that user to conduct the aforementioned transaction. A person skilled in the art will recognize that the term online in this case should be interpreted in the broadest sense to include an electronic or optical mechanism including but not limited to the use of mobile phones to conduct the transaction.

The method may include the case where the event is an indoor event such as but not limited to a movie, concert, play, performance, exhibition, sporting match, or competition.

The method may include the case where the event is an outdoor event such as but not limited to a movie, concert, play, performance, exhibition, sporting match, or competition.

### BRIEF DESCRIPTION OF THE DRAWINGS

FIG. 1 is a block diagram of a simplified representation of an Audience Validation System.

FIG. 2 is a block diagram illustrating the extension of the Audience Validation System to include functionality for Integrating Offline Event Information.

FIG. 3 is a block diagram of a process for creating an Association between a Ticket and a User.

FIG. 4 is a block diagram of a simplified process for Acquiring Information regarding Additional Attendees and Associating it with their browsing behavior.

FIG. 5 is a block diagram of a simplified process for Confirming Attendance at an Event

FIG. 6 is a block diagram of a simplified process for Determining Media Exposure

FIG. 7 is a block diagram of a simplified process for Post Event Conversion Tracking

### DETAILED DESCRIPTION

Further features and embodiments will become apparent from the following detailed description.

Additional Attendee Acquisition Methods

According to another aspect, although not necessarily the broadest or only aspect embodiments of the invention the method may also include the additional step of confirming the anonymized identities of persons other than the transaction initiator by allowing the inclusion of additional information about these people.

This method may also include the case where the additional anonymized identity confirming information is gathered during the transaction process.

This method may also include the case where the additional anonymized identity confirming information is gathered after the transaction process.

This method may also include the case where the use of an online identity, such as but not limited to an email address or social networking account handle (e.g. Facebook® of Facebook Inc. account name), is used to send a notification to the other persons who, through the accessing of the notification, would initiate the execution of a universal tag on the associated media thereby creating an association between the event booked by the originating user and the anonymized identify of the person or persons being notified.

The method may also include the case where the use of event management services on a third party site such as, for example without limitation, Facebook® (of Facebook Inc.) events incorporates the use of universal tags within the event acceptance functionality presented to event invitees either pre or post the booking being made.

This method may also include the case where the use of a mobile phone identify, such as but not limited to a mobile phone number, is used to send an SMS, MMS or similar notification to the other persons who through the accessing of the notification would initiate the execution of a universal tag on the associated media thereby creating an association between the event booked by the originating user and the anonymized identify of the person or persons being notified.

Attendee Confirmation Acquisition Methods

According to another aspect, although not necessarily the broadest or only aspect embodiments of the invention the method may also include the additional step of confirming the attendance of the people at the event corresponding to the transaction that was made using a tracking server infrastructure.

This method may also include the case whereby the attendance at the event by a particular person is confirmed by a tracking server infrastructure by scanning, processing, or otherwise electronic or optical verification of a physical or electronic ticket that is presented or otherwise sensed upon entry to the venue. This includes RFID or radio-frequency identification tags incorporated into tickets and optical barcodes displayed on an electronic device, such as a mobile phone, by the ticket holder for entry.

This method may also include the case whereby the attendance at the event by a particular person is confirmed by the tracking server infrastructure by the person's phone accessing or connecting to a wireless network or other event based communication infrastructure such as but not limited to a mobile phone network, Wi-Fi® (of the Wireless Fidelity Alliance, Inc.) network, WiMAX™ (of the WiMAX Forum) network, or Bluetooth® (of Bluetooth SIG, Inc.) network with one or more access points that are in or near the venue.

This method may also include the case whereby the attendance at the event by a particular person is confirmed by the tracking server infrastructure by the person using a GPS or similarly geo-location aware device to submit a message or other contribution to a third-party network involving multiple registered persons (e.g. a social networking site such as Facebook® of Facebook Inc., Twitter® of Twitter Inc., or LinkedIn® of the LinkedIn Corporation, or a location identification network such as Google Latitude™) that identifies them as being present at that event.

This method may also include the case whereby the attendance at the event by a particular person is confirmed by the tracking server infrastructure by the person using a third-party device connected to the event based communication infrastructure, such as but not limited to an online kiosk, at the event during which they supply sufficient identifying information such as but not limited to their mobile phone number or an online identity handle that can subsequently be associated with the original transaction.

Media Exposure Confirmation Methods

According to another aspect, although not necessarily the broadest or only aspect embodiments of the invention the method may also include the additional step of determining the exposure of the ticketholders to specific media displayed at specific times at specific locations at the event corresponding to the transaction that was made.

The method may also include the additional steps of using information related to the event tickets purchased including but not limited to:

The class of ticket(s) and the access rights associated with the ticket(s) to specific areas within the event venue.

The position of the seat(s) within the event relative to advertising and media placements within the event.

The method may also include the additional steps of using information related to the movement of the ticket holder within the event venue to determine the exposure of the ticket holder to specific media displayed at specific times at specific locations at the event corresponding to the transaction that was made:

The location of a Mobile Device such as but not limited to a phone, a personal digital assistance.

Credit Card Transactions Made Within the Venue

The method may also include the additional steps of providing actionable information on media to enable ticketholders to respond to a call to action. Examples of actionable information include but are not limited to the inclusion of RFIDs, URLs, barcodes, or other graphical or locally accessible visual or audio representations that a ticket holder may subsequently use to access additional information using an electronic device such as or not limited to a smartphone or a personal computer.

Post Event Conversion Tracking Methods

According to another aspect, although not necessarily the broadest or only aspect embodiments of the invention the method may also include the additional step of surveying the user from a site that contains the universal tag with a survey that is tailored to those who have attended a specific event.

The method may also include the ability to query and ascertain brand engagement regarding specific brands for which advertising was either shown or not shown at the event to which the user may or may not have been exposed.

According to another aspect, although not necessarily the broadest or only aspect embodiments of the invention the method may also include the additional step of providing conversion tracking for advertisements and direct-marketing offers presented to the user after the event in which the advertisement or direct-marketing offer contains the universal-tag

The method may also include the ability to track landing page conversions

The method may also include the ability to link multiple transactional purchases to the ticket holder.

This method may also include the ability to analyze aggregate changes in trends, such as an uptick in visitors after an event, or a higher conversion rate and incidence of event attended people re-registering, purchasing or engaging more fully with a website or company.

Post Event Advertisement Re-targeting

According to another aspect, although not necessarily the broadest or only aspect embodiments of the invention the method may also include the additional step of allowing the use of event-identifying information contained within the tag to re-target advertisements and direct-marketing offers based on event-attendance.

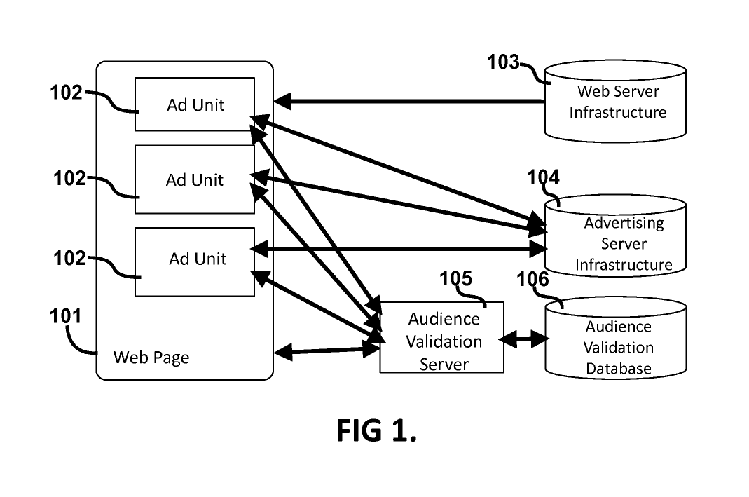

FIG. 1 is a block diagram of a highly simplified representation of an Audience Validation system. Web pages 101 or applications (not shown) will include Ad Units 102 that contain code to retrieve an advertisement from one or more Ad Serving Infrastructure 104 instances operated by one or more entities such as advertisers, advertising networks, or advertising agencies. In one embodiment, the system utilizes a separate previously disclosed invention that allows the web page 101 or application (not shown) and any embedded Ad Units 102 it contains to contain a universal common tag. Such tags are described in the Australian Patent application 2009201196 “Computer implemented website usage measuring systems, methods, and apparatus” and are incorporated by reference herein. When executed, this tag, typically implemented in JavaScript or some other client side scripting language, collates local data and returns it to an Audience Validation Server 105. The tag is constructed in such a way that it can access local shared objects, first-party cookies, and third party cookies, thereby enabling the regeneration of unique anonymized identifiers for a particular user in the event that any two of the three accessible data-items is deleted. The Audience Validation Server 105 integrates the calls across multiple ad units and any content calls to register a single impression of the page with a specific user who is identified using persistent data stored on the client (such as, for example without limitation, the data disclosed in Australian Patent application 2009201196 “Computer implemented website usage measuring systems, methods, and apparatus”). In this fashion the Audience Validation Server is able to create a de-duplicated and unified view of the consumption habits of individual users accessing multiple sites and content that has deployed the universal common tag. The aggregated anonymized consumption habits of users are stored in the Audience Validation Database 106 which can then provide independent verified data as to exactly how many users are visiting particular sites and viewing specific pieces of content.

As part of the processing of one or more tags from a piece of content the Audience Validation Server 105 can optionally trigger the launch of a survey on the piece of content. This survey typically contains a set of anonymized demographic questions that can be answered by the user viewing the content. When the user responds to the questions, the answers are associated with the Unique ID that has been assigned to the user and stored in the Audience Validation Database 106.

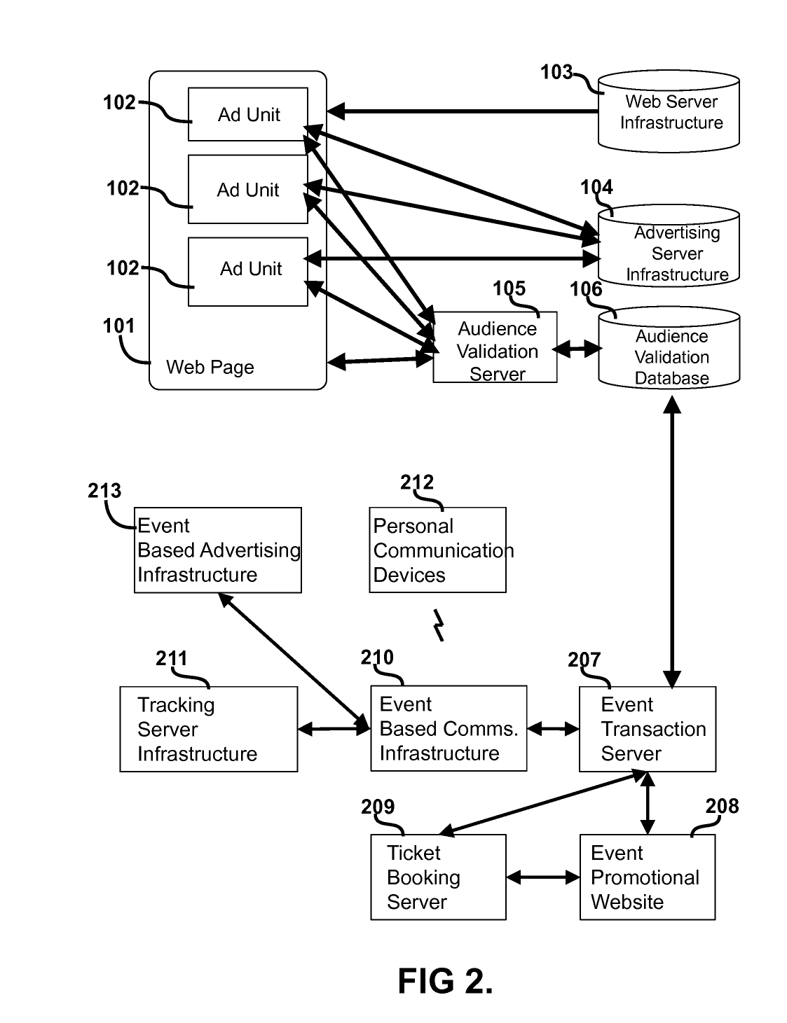

FIG. 2 is a block diagram of a simplified version of how the Audience Validation System shown in FIG. 1 can be integrated into the ticketing system for an event. At the core of the system lies the event transaction server 207 which tracks the data generated by the people before and during, and optionally after the event. The process starts when a person wishing to attend an event contacts an Event Promotional Website 208 or service to obtain tickets. Typically the user contacts an Event Promotional Website 208 promoting the event and from this site books one or more tickets from a Ticket Booking Server 209. Those skilled in the art will realize that this process may also be transacted via a mobile phone or personal communication device to access the website or via voice over a phone to an operator who conducts the transaction on the user's behalf.

During the booking process the user will, be by necessity, reveal identifying information that allows an association to be made between the person making the booking to attend the event, possibly identifying information on other people who will attend the event with that person, and the browsing behavior of those people for whom identifying information has been made available. For example, if the user makes a booking using a web browser. In one embodiment, the Tracking Server Infrastructure 211 confirms the attendance of the user and/or the exposure of the user to advertisements. The Tracking Server Infrastructure 211 communicates through the Event Based Communication Structure 210 to the Event Transaction Server 207. For example, in one embodiment, the user communicating with the Event Based Communications Infrastructure 210 through a personal communication device 212 confirms attendance at the event. The Event Based Advertising Infrastructure 213 also communicates across the Event Based Communication Infrastructure 210 and delivers advertising to be seen by the user.

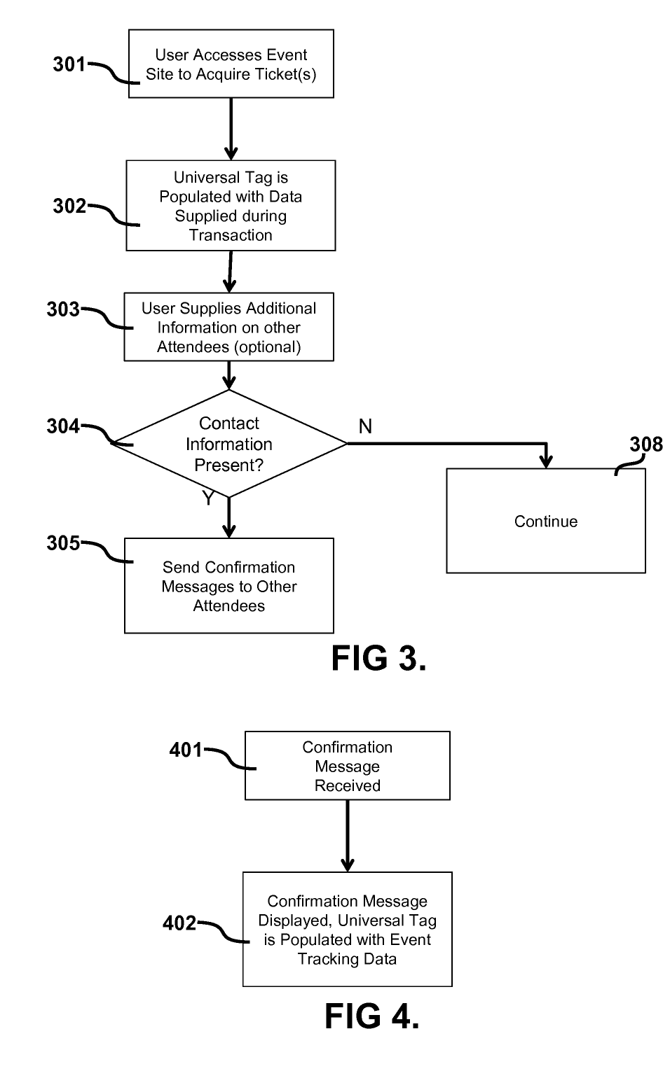

FIG. 3 is a block diagram of a simplified process for creating an association between a ticket purchase and one or more users who will attend the event. The process starts with a user accessing an online (which can include mobile) site promoting the event from which tickets can be purchased or reserved 301. During the course of effecting the transaction the user will supply data about themselves 302 that can be subsequently be associated with subsequent browsing behaviors. In the simplest form the data might simply be the fact that the person associated with the session has made a decision to acquire a ticket for an event and the events name. More complex embodiments may include additional information about the event, such as but not limited to the performance name, venue, date, and time of the event, an additional information about the ticket purchaser, such as but not limited to the person's post code, gender, or age. Another possible extension could include the ability to identify other persons for whom the ticket purchaser is purchasing tickets 303 and the ability to send them notifications that a ticket has been purchased 305. In one embodiment, the presence of contact information is checked 304 and if there is no information present, the process continues 308 or if there is information present, confirmation messages may be sent to other attendees 305.

FIG. 4 is a block diagram of the operations performed by a browser with an additional attendee where the ticket acquirer supplied additional attendee and contact information. In this case the subsequent reception 401 and display 402 of a confirmation message by the additional attendee would typically trigger a universal tag contained within the confirmation message that would then populate a local shared object (302 in FIG. 3) associated with the event information appropriate for that user from and optionally also send this information back to a centralized server.

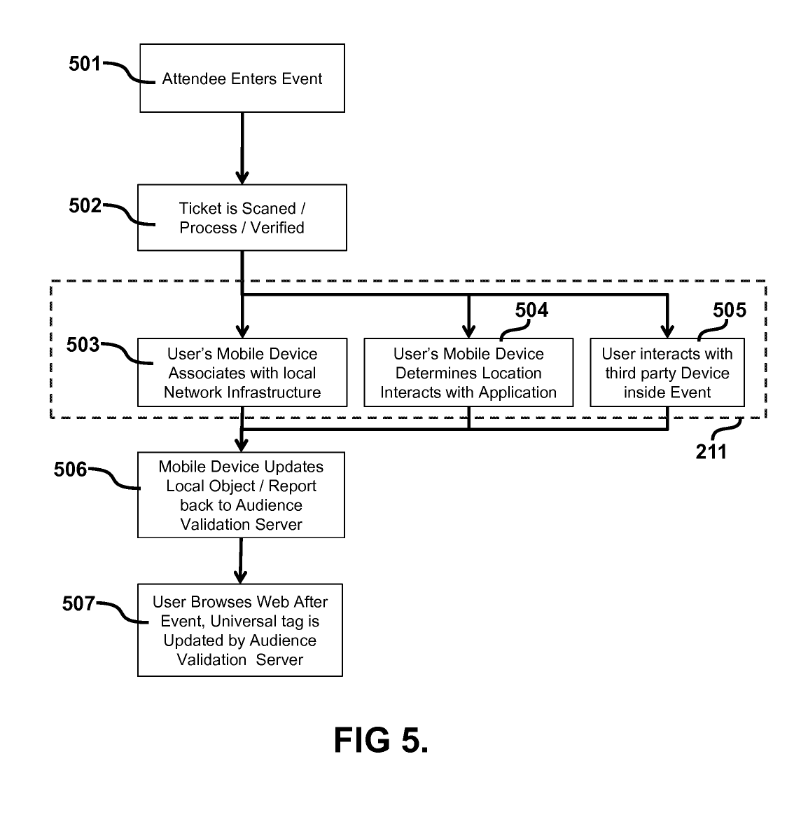

FIG. 5 is a block diagram of a simplified process for confirming that ticket holders have indeed attended the event. The process starts with the ticket holder entering the venue 501 upon which the ticket is verified either manually or using some kind of scanning device 502. In the case where the ticket is scanned or validated using some other kind of electronic means the fact that the ticket has been validated can be communicated by the Tracking Server Infrastructure 211 through the event based communication infrastructure to the event transaction server which may populate the local shared object on browsers associated with the local shared object associated with that ticket as determined from the process outlined in FIG. 3 and/or FIG. 4.

Additional methods for confirming event attendance by a Tracking Server Infrastructure 211 are shown in steps 503, 504, and 505.

In step 503 the user may have a mobile device, such as but not limited to a phone, that associates with network infrastructure near to or within the event, such as a mobile phone tower, or wireless Wi-Fi® (of the Wireless Fidelity Alliance, Inc.) access point, WiMAX™ (of the WiMAX Forum) access point, or other wireless communication access point. In this case it may be possible to determine from the device's identity during this process and to communicate the fact that device (and hence the device's user) has been observed at the event back to a central server (in real time or after the fact) which may populate the local shared object on browsers associated with the local shared object associated with that ticket 506 as determined from the process outlined in FIG. 3 and/or FIG. 4.

In step 504 the user possessing a mobile device may interact with an online service, an application or locally hosted service, an application that is only accessible within the event venue, or a combination thereof. This interaction will require higher application and session level interactions from the device than the network and data-link interactions used in step 503 and enable the service/application to potentially directly access geo-location functionality on the device, such as that enabled by the use of HTML 5. In this case the service/application can execute the universal tag code directly to update the local shared object and then optionally communicate the updated information to the central server 506. This could also be embedded within a mobile or other device, such as a custom event application for an iPhone® phone (by Apple Inc.) application, or a more general application in the case of a location aware sporting application (app) which can correlate time and date with location to confirm attendance.

In step 505 the ticket holder has an interaction with a kiosk or some other kind of networked device inside the venue during which he or she reveals sufficient information to confirm the attendance of the person associated with a specific ticket. After identity has been confirmed then the process is analogous to that for step 503 for the kiosk to communicate the fact that a ticket holder has been observed at the event back to a central server which may populate the local shared object on browsers associated with the local shared object associated with that ticket 506 as determined from the process outlined in FIG. 3 and/or FIG. 4.

A second ticket holder may also interact with first ticket holder who has been confirmed in attendance. Through software and interaction with the first ticket holder's mobile device (optionally along with time and location information), the second ticket holder may be confirmed in attendance. For example, the second ticket holder could be Tagged in a photo, or identified as a person in attendance using a third party social network such as an application on Facebook® of Facebook Inc. Similarly, a person Tagged in a photo with a geotag location identified as being at the event could be verified as being in attendance.

The user may also provide information and event attendance validation through purchases made at the event. Examples include location specific transactions such as credit card transactions from vendors, stores internal to the event, etc. and other forms of electronic transactions such as Mobile web payment (WAP billing), premium SMS based transactional payments, Direct Mobile Billing, and Contactless NFC (Near Field Communication).

Those skilled in the art will realize that step 506 consists of two sub steps that have been combined and that the order of the sub-step to contact the server to update the attendance information and the sub-step to update the local object on a mobile device browser or a browser on a personal computing device associated with the user (such as a laptop, tablet PC, or PC) is dependent up on the source of the confirmation event information and whether or not this information is directly available to the computing device or must be synchronized through a centralized server first. When the browses the web after the event, the Universal tag is updated by the audience validation server 507.

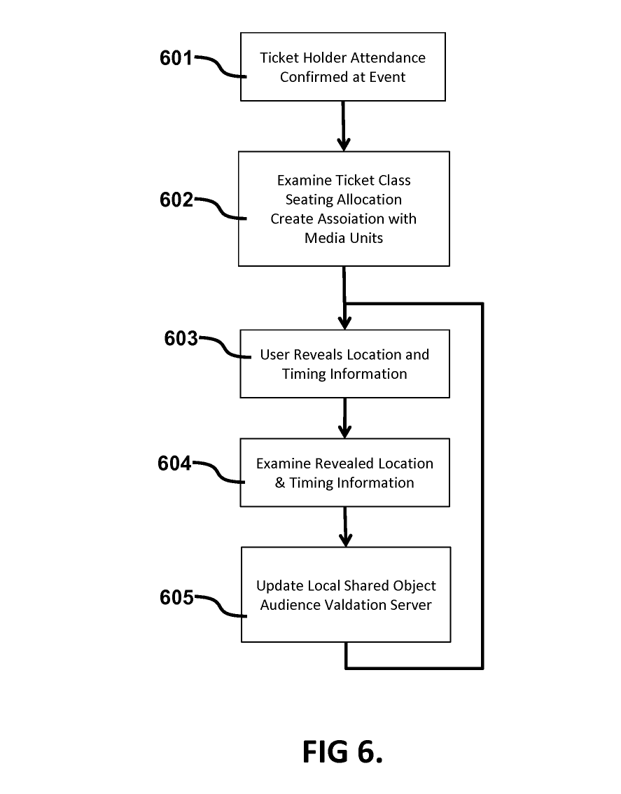

FIG. 6 is a block diagram of a simplified process for determining the media exposure of event attendees to particular media within the event venue by the tracking server infrastructure. After the ticket holder has been confirmed at being at the event 601, the ticket information and time of entry are examined to determine which media the event holder can be exposed to by virtue of the ticket class and position of the seating 602. This enables advertising that is not physically visible to that ticket holder to be removed from the validation system.

As the attendee moves through the venue or a General Admission event where the attendee does not have an allocated seat, he or she may reveal his or her location to the tracking server infrastructure via a variety of methods 603 as shown in FIG. 5. Should this happen then the attendees identifying information and location information is examined to determine which media the attendee will be exposed to by virtue of being at that location at the time the location was revealed 604. This information is then used to update the local shared object as well as the information stored on the Audience Validation Server 605. Those skilled in the art will realize that the process just described is the offline equivalent of the online process for registering an impression of an advertising unit displayed on a web page.

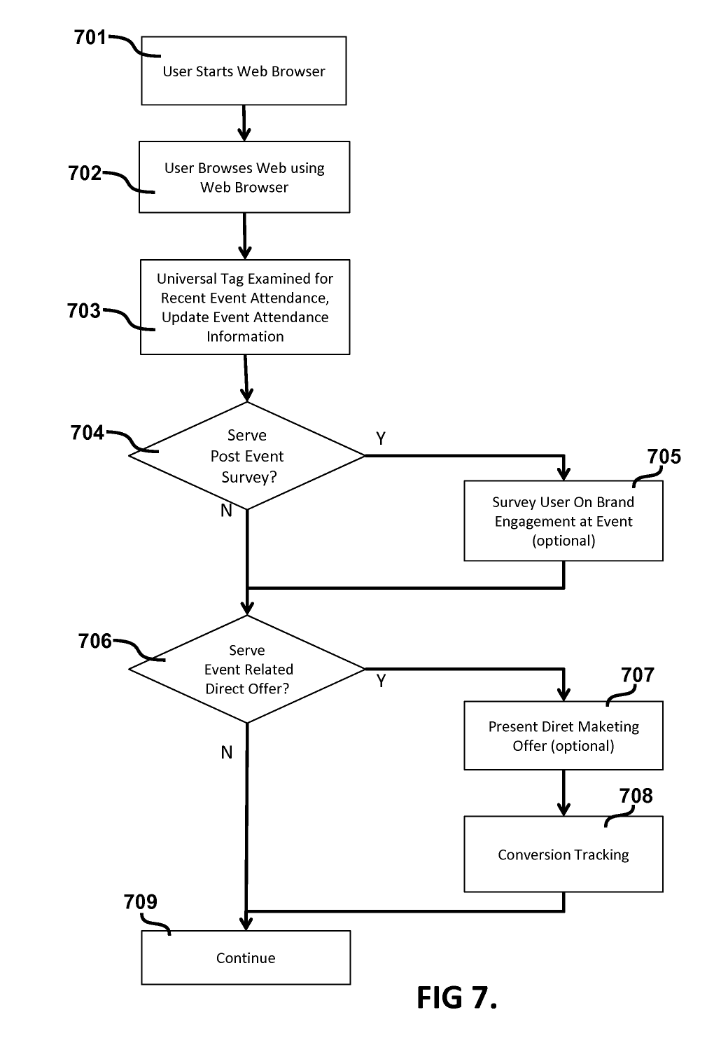

FIG. 7 is a block diagram of a simplified process for post-event conversion tracking that modifies the standard online-only audience validation system. The modified process starts off as before with the user launching a web browser 701 and then browsing websites 702. Each time a user visits a site or accesses content that has been tagged with a Universal Tag that tag will be executed. The Universal tag contain state stored in a local shared object stored on the access device that contains a variety of data regarding the user's browsing habits, including which events the user has booked tickets to attend and which they have attended recently, as well as media exposure information as outlined in the process described in FIG. 6. This information is examined by the universal tag 703 which also contacts the Audience Validation Server to obtain any additional event information that may have been gathered using other devices or acquisition channels.

Based on the recent consumption history of the user, including which advertisements have been served to the user and the user's survey history the Audience Validation Server may decide to serve a survey to the user that is related to an event that they have just booked or just attended 704. If a survey is to be served then it is presented to the user using the standard survey launch mechanism 705. The Audience Validation Server may also decide to serve an offer directly related to an event that a user has just booked or just attended 706. If a direct marketing offer is to be served then it is presented to the user using the standard advertisement launch mechanism 707 before continuing 709. In a manner similar to that of the event ticket booking the Universal Tag is also capable of being embedded in a shopping cart or multi-stage conversion funnel, thereby enabling full pipe-line conversation tracking 708 such as would be required to properly track Cost-Per-Action (CPA) advertising.

The Audience Validation Server, Advertising Server Infrastructure, Web Server

Infrastructure, Event Based Advertising Infrastructure, Tracking Server Infrastructure, Event Based Communications Structure, Event Transaction Server, or any combination of the aforementioned or presented herein servers, infrastructures, databases, portals, panels, web pages or other elements can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output.

The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks.

Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks.

Any of the foregoing can be supplemented by, or incorporated in, ASICs (application-specific integrated circuits).

Those skilled in the Art will realize that certain steps described in this process may be transposed without material effect on the operation of the invention. Accordingly, the invention is not to be considered limited to the exact ordering and steps as shown and may include additional steps or processes.

### Equivalents

Those skilled in the art will recognize, or be able to ascertain using no more than routine experimentation, numerous equivalents to the specific procedures described herein. Such equivalents are considered to be within the scope of the invention. Various substitutions, alterations, and modifications may be made to the invention without departing from the spirit and scope of the invention. Other embodiments, advantages, and modifications are within the scope of the invention. This application is intended to cover any adaptations or variations of the specific embodiments discussed herein. Therefore, it is intended that this disclosure be limited only by the claims and the equivalents thereof

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

What is claimed is:

1. A system comprising:
a. a web serving infrastructure for delivering surveys with content tagged with a universal tracking tag associated with a person to electronic devices;
b. a transaction serving infrastructure that collects ticket purchase information by the person for an event or the intention of the person to attend an event; and
c. a tracking server infrastructure that confirms the attendance of the person at the event.

2. They system of claim 1 wherein the web serving infrastructure serves a direct marketing offer to the person based on their confirmed attendance at the event or their confirmed exposure to one or more advertisements served at the event the person attended.

3. The system of claim 1 wherein event attendance information of the person is associated with the universal tracking tag associated with the person.

4. They system of claim 3 wherein the web serving infrastructure serves a direct marketing offer to the person based on the event attendance information in the universal tracking tag associated with the person.

5. They system of claim 4 wherein the universal tracking tag comprises information on the user's response to the direct marketing offer.

6. The system of claim 1 further comprising an advertising serving infrastructure that serves one or more advertisements to an advertising infrastructure for the event, wherein the tracking server infrastructure tracks exposure of the person to the one or more advertisements at the event.

7. The system of claim 6 wherein the selection of the one or more advertisements served is determined in part by the universal tag associated with the person confirmed in attendance by the tracking server infrastructure.

8. The system of claim 6 further comprising a survey server that serves a survey to the person based on their confirmed attendance at the event or their confirmed exposure to the one or more advertisements at the event they attended by the tracking server infrastructure.

9. The system of claim 6 wherein the tracking server infrastructure tracks the exposure of the person to the one or more advertisements based on at least one selected from the group of: the locations for the class of the ticket purchased by the person for the event, the location of the person's seat at the event, the location of a mobile device associated with the person at the event, and a credit purchase transaction made at a location at the event.

10. The system of claim 6 wherein the tracking server infrastructure tracks the exposure of the person to the one or more advertisements based on actionable media information.

11. The system of claim 6 wherein the tracking server infrastructure confirms the attendance of the person at the event through location information derived by the use of a wireless network by a mobile device associated with the person.

12. The system of claim 6 wherein the tracking server infrastructure confirms the attendance of the person at the event through device or person location information submitted using an application on a mobile device or a third-party network accessed by a mobile device.

13. The system of claim 6 wherein the tracking server infrastructure confirms the attendance of the person at the event through the person's interaction with an electronic device located at the event location.

14. The system of claim 1 further comprising an advertising serving infrastructure that serves one or more advertisements to a mobile device associated with the person in confirmed attendance the event.

15. A method of serving content comprising:
a. collecting survey response information from a person using an electronic device and storing the information in a universal tracking tag associated with the person;
b. collecting ticket purchase information or intent to attend an event information for a person and storing the information in the universal tracking tag;
c. confirming the attendance of the person at the event and storing the attendance information in the universal tracking tag; and
d. serving advertising content or survey content to the person based on the event attendance information of the universal tracking tag associated with the person.

16. The method of claim 15 wherein the attendance of the person at the event is derived by location information derived by the use of a wireless network by a mobile device associated with the person.

17. The method of claim 15 wherein the attendance of the person at the event is derived by device or person location information submitted using an application on a mobile device or a third-party network accessed by a mobile device.

18. The method of claim 15 wherein the attendance of the person at the event is derived by the person's interaction with an electronic device or actionable media information located at the event location.

19. A method of serving content comprising:
a. collecting survey response information from a person using an electronic device and storing the information in a universal tracking tag associated with the person;
b. collecting ticket purchase information and storing the ticket purchase information in the universal tracking tag or collecting intent to attend an event information for a person and storing the intent to attend information in the universal tracking tag;
c. tracking the exposure information of the person to one or more advertisements served at the event and storing the exposure information in the universal tracking tag; and
d. serving advertising content or survey content to the person, the content selected in part based on the exposure information in the universal tracking tag.

20. The method of claim 19 wherein tracking the exposure of the person to the one or more advertisements is based on at least one selected from the group of: the locations for the class of the ticket purchased by the person for the event, the location of the person's seat at the event, the location of a mobile device associated with the person at the event, and a credit purchase transaction made at a location at the event.
